(19) United States
(12) Patent Application Publication
(10) Pub. No.: US 2004/0183903 A1
(43) Pub. Date: Sep. 23, 2004

(54) Method and system for managing data in a system

(76) Inventor: Christen Kent Pedersen, Sunnyvale, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/394,467

(22) Filed: Mar. 21, 2003

(51) Int. Cl. H04N 7/18

(52) U.S. Cl. 348/143

(57) ABSTRACT

A method and system for managing data in a system is disclosed. The method and system include the utilization of a programmable algorithm to periodically discard data in a memory component of a system. By utilizing a programmable algorithm to periodically discard data in the memory component of a system, data can be recorded over long periods of time at varying degrees of temporal and spatial resolution without the use of cumbersome video tapes and the like. Using the method and system in accordance with the present invention allows a user to select particularly useful data from the large amount of stored data and save it to a more permanent storage device. The method and system include receiving data from an input portion of the system, storing the data in a solid state memory portion of the system and utilizing a programmable algorithm to reduce the amount of the data stored in the solid state memory portion of the system.

### FIELD OF THE INVENTION

The present invention relates to data capturing systems, and more particularly to a method and system for managing data in a data capturing system.

### BACKGROUND OF THE INVENTION

Data capturing systems such as video security systems utilize video cameras to generate video signals representative of locations for which security surveillance is desired. In a typical system, some or all of the video signals are displayed on video screens for monitoring by security personnel. Some or all of the video signals are recorded on videotape, either to provide evidentiary support for the observations of security personnel or in cases where “real-time” human monitoring of the signals is impractical or is not desired.

However, videotape suffers from serious drawbacks as a storage medium, particularly in view of the large quantity of video information generated by video security systems. A major concern is the sheer quantity of tapes to be stored, especially when it is desired to record signals generated by a large number of surveillance cameras. Moreover, in a large system many videotape recorders may be required, resulting in a large capital expenditure, and also the need to allocate space for the recorders. Another problem is the need to frequently change tape cassettes.

Retrieving information of interest from recorded tapes presents additional challenges. It is the nature of video surveillance that a large part of the tape-recorded video surveillance signal is of no interest whatsoever, since it typically represents a static image of a hall-way or the like. Since video tapes are a linear storage mechanism, it is nearly impossible to selectively and dynamically decimate the data on the tape. Consequently, finding a particular sequence representing a significant event can be extremely difficult and time-consuming, requiring tedious human review of hours or days of tape-recorded signals.

There have been a number of attempts to overcome these disadvantages, but so far with limited success, or at the cost of additional drawbacks. For example, it is known to use “quad multiplexers” to combine signals from four video cameras into a single dynamic image, having four quadrants each dedicated to a respective one of the cameras. The resultant space-multiplexed signal can then be recorded, realizing a four-to-one compression ratio in terms of required storage medium. However, the multiplexed image suffers from a corresponding loss of spatial resolution, which may impair the value of the recorded images as evidence or may interfere with subsequent review. Also, the recording of multiplexed images does not address the problems involved in finding sequences of interest on the recorded tapes.

It is also known to record the surveillance video signals selectively in response to input from a human operator who is monitoring the signals or in response to signals generated by sensor devices arranged to detect events such as opening of doors or windows. This technique reduces the total information to be recorded, while preventing storage of much uninteresting information, but at the risk of failing to record significant events which cannot readily or timely be detected by sensors or human operators. Also, reliance on external input can result in unreliability and increased expense, particularly where human operators are to initiate recording.

Accordingly, what is needed is a method and system that eliminates the cumbersome video cassette tapes and the related short comings thereof. The method and system should be simple, cost effective and capable of being easily adapted to existing technology. The present invention addresses these needs.

### SUMMARY OF THE INVENTION

The present invention includes a method and system for managing data in a system. According to the present invention, a method and system includes the utilization of a programmable algorithm to periodically discard data in a memory component of a system. By utilizing a programmable algorithm to periodically discard data in the memory component of a system, data can be recorded over long periods of time at varying degrees of temporal and spatial resolution without the use of cumbersome video tapes and the like. Additionally, through the use of the method and system in accordance with the present invention, a user can select particularly useful data from the large amount of stored data and save it to a more permanent storage device.

A first aspect of the present invention includes a method for managing data in a system. The method includes receiving data from an input portion of the system, storing the data in a solid state memory portion of the system and utilizing a programmable algorithm to reduce the amount of the data stored in the solid state memory portion of the system.

A second aspect of the present invention includes a system for managing data. The system includes a sensor input for receiving the data, a solid state memory portion for storing the data and implementation means coupled to the sensor input and the solid state memory portion for implementing a programmable algorithm to reduce the amount of the data stored in the solid state memory portion of the system.

A third aspect of the present invention includes a video surveillance camera. The video surveillance camera includes a sensor input for receiving the data, a randomly accessible memory for storing the data and a microprocessor coupled to the sensor input and the randomly accessible memory for implementing a programmable algorithm to reduce the amount of the data stored in the randomly accessible memory of the system wherein the programmable algorithm includes periodically checking an amount of available storage in the randomly accessible memory and reducing the amount of data in the randomly accessible memory based on the amount of available storage in the randomly accessible memory. The camera further includes an interface coupled to the randomly accessible memory for providing access to a portion of data in the randomly accessible memory.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a high-level flow chart of a method in accordance with an embodiment of the present invention.

FIG. 2 is a block diagram of a data capturing system in accordance with an embodiment of the present invention.

FIG. 3 shows a flow chart of the implementation of the storage reduction algorithm in accordance with an embodiment of the present invention.

FIG. 4 is a block diagram of a video surveillance camera system in accordance with an embodiment of the present invention.

FIG. 5 shows an example of a system in accordance with an alternate embodiment of the present invention.

FIG. 6 shows a block diagram of hardware that could be included in a remote data accessing device that could be utilized in accordance with an alternate embodiment of the present invention.

FIG. 7 shows a non-exhaustive list of relay interfaces which may be included in a remote data accessing device in accordance with an alternate embodiment of the present invention.

FIG. 8 shows a non-exhaustive list of I/O devices which may be included in the remote data accessing device in accordance with an alternate embodiment of the present invention.

FIG. 9 shows a flowchart of a method in accordance with an alternate embodiment of the present invention.

FIG. 10 shows a system in accordance with another embodiment of the present invention.

FIG. 11 shows a flowchart of a method in accordance with another embodiment of the present invention.

### DETAILED DESCRIPTION

The present invention relates to a method and system for managing data in a system. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention includes a method and system for managing data in a system. According to the present invention, the method and system includes the utilization of a programmable algorithm to periodically discard data in a memory component of a system. By utilizing a programmable algorithm to periodically discard data in the memory component of a system, data can be recorded over long periods of time at varying degrees of temporal and spatial resolution without the use of cumbersome video tapes and the like. Additionally, through the use of the method and system in accordance with the present invention, a user can select particularly useful data from the large amount of stored data and save it to a more permanent storage device.

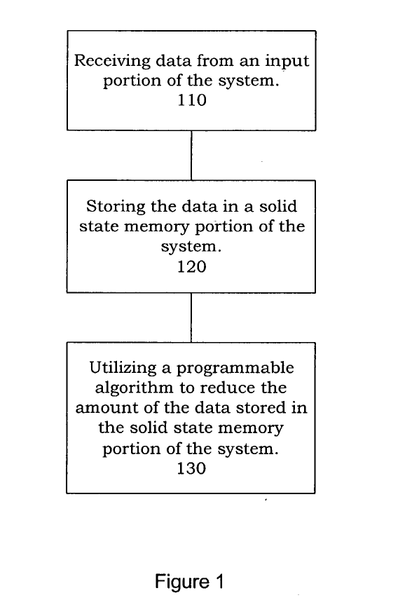

FIG. 1 is a flowchart of a method in accordance with an embodiment of the present invention. A first step 110 includes receiving data from an input portion of a data capturing system. The next step 120 includes storing the data in a solid state memory portion of the system. The final step 130 includes utilizing a programmable algorithm to reduce the amount of the data stored in the solid state memory portion of the system.

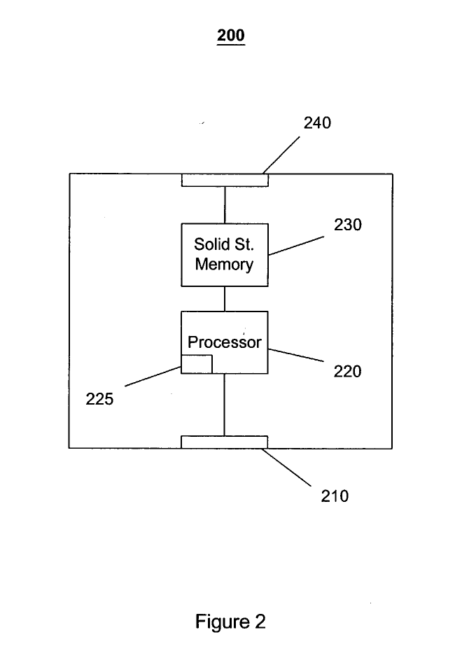

FIG. 2 is a block diagram of a data capturing system 200 in accordance with an embodiment of the present invention. As shown in FIG. 2, the data capturing system 200 includes an input portion 210 for receiving data, a microprocessor 220, a memory portion 230 and an input/output (I/O) interface 240. The input portion 210 and the memory portion 230 are coupled to the microprocessor 220 and the I/O interface 240 is coupled to the memory portion 230.

The input portion 210 transmits data to the microprocessor 220 for processing. The microprocessor 220 receives the transmitted data and transmits the data to the memory portion 230. In an embodiment, the memory portion 230 is a solid state component. A solid state component is an electronic component or circuit made of solid materials, such as transistors, chips and bubble memory. In an embodiment, the memory portion 230 is a random-access memory (RAM) wherein the RAM can be a contiguous block of dynamic memory which may be selectively rewritten (e.g. flash RAM, hard drive memory, SRAM, DRAM, etc.).

Because the memory portion 230 has a finite storage capacity, a programmable storage reduction algorithm 225 is implemented by the microprocessor 220 once the memory portion 230 reaches a predetermined percentage (e.g. 90%, 95%, etc.) of it's storage capacity. The storage reduction algorithm 225 can be contained within a programmable memory component in the microprocessor 220. Utilizing the storage reduction algorithm 225, the memory portion 230 is periodically checked to determine whether it has reached the predetermined percentage of the storage capacity. If the memory portion 230 has reached the predetermined percentage, the microprocessor 220 selectively reduces the amount of data being stored in the memory portion 230 by removing specific portions of the data thereby “freeing up space” in the memory portion 230.

One of ordinary skill in the art will readily recognize that a variety of different types of data could be utilized in conjunction with the present invention. For example, video data, audio data, and still-picture data is a non-exhaustive list of the types of data that could be employed by the data capturing system 200 while remaining within the spirit and scope of the present invention.

Because the storage reduction algorithm 225 is programmable, the parameters by which the amount of data in the memory portion 230 are to be reduced is user selective. Accordingly, a system user can configure storage reduction algorithm 225 to reduces the amount of data being stored in the memory portion 230 based on how much data she wants removed, how fast she wants the data to be removed, how the data should be removed, etc.

In an embodiment, the components of the data capturing system 200 are utilized in conjunction with a video camera system and the captured data includes high resolution video data frames. Utilizing the storage reduction algorithm 225, once it is determined that the memory portion 230 has reached a predetermined percentage of it's storage capacity, the microprocessor 220 is instructed to reduce the amount of data being stored in the memory portion 230 wherein reducing the amount of data being stored in the memory portion 230 could involve erasing older data frames or simply lowering the resolution of one or more of the data frames.

Again, because the storage reduction algorithm 225 is programmable, the amount of data being stored can be reduced from the memory portion 230 in a variety of ways. For instance, the data can be erased on a frame in/frame out basis whereby storage capacity for a frame of data is reduced from the memory portion 230 for every frame of data captured by the system 200. Alternatively, the amount of data being stored can be reduced from the memory portion 230 on a multiple frame basis, e.g. for every five hundred frames of data captured by the system 200, the storage capacity for 500 frames of data is reduced from the memory portion 230.

Additionally, determining what data to remove from the memory portion 230 can be programmed into the storage reduction algorithm 225. For example, data does not have to be reduced from the memory portion 230 in a sequential fashion. In an embodiment, the amount of data being stored can be reduced from the memory portion 230 based on every Nth frame of data (where N equals 10, 100, 500 etc.). Also, data can be reduced from the memory portion 230 based on the time at which the data was captured whereby older frames are reduced in resolution or erased before more recently captured data frames.

Because the storage reduction algorithm 225 is utilized to selectively free up storage space in the memory portion 230, longer periods of time can be recorded with the data capturing system 200. Consequently, especially valuable data from a particular moment in time can be accessed from the memory portion 230. Additionally, since longer periods of time can be recorded with the system 200, less obvious events from a day, a week or a month earlier can be accessed from the memory portion 230 as well.

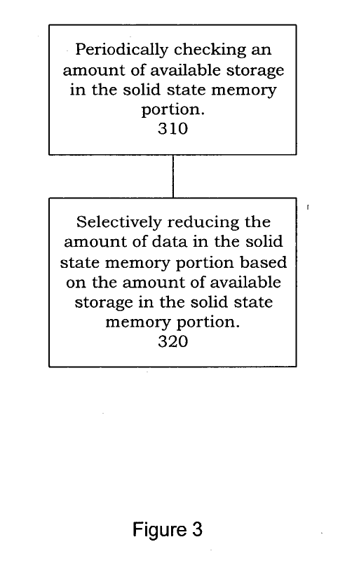

FIG. 3 shows a flow chart of the implementation of the storage reduction algorithm 225 in accordance with an embodiment of the present invention. A first step 310 involves periodically checking an amount of available storage in a solid state memory portion of a data capturing system. A final step 320 includes selectively reducing the amount of data in the solid state memory portion of the data capturing system based on the amount of available storage in the solid state memory portion. In an embodiment, this step involves either erasing data frames from the solid state memory portion or lowering the resolution of data frames in the solid state memory portion.

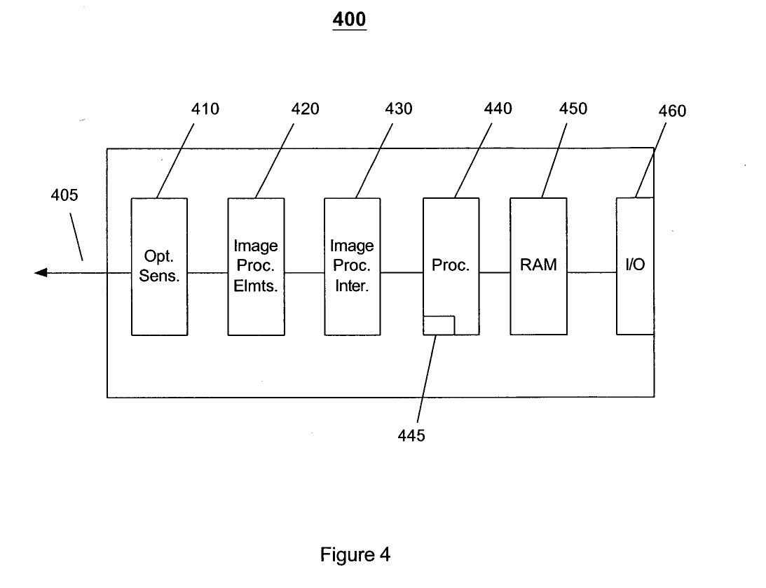

In an embodiment, the components of the system 200 are utilized in conjunction with a video surveillance camera system. FIG. 4 is a block diagram of a video surveillance camera system 400 in accordance with an embodiment of the present invention. The video surveillance camera system 400 includes an optical sensor 410, image processing elements 420, an image processing interface 430, a microprocessor 440, a RAM 450 and an I/O interface 460. The optical sensor 410 is coupled to the image processing elements 420 and the image processing elements 420 are coupled to the image processing interface 430. The microprocessor 440 is coupled to the image processing interface 430 and the RAM 450 wherein the RAM 450 is coupled to the I/O interface 460.

In operation, the lens 410 captures real-time images of objects via reflected light along optical path 405. The raw image data can then be routed through the image processing elements 420 and the image processing interface 430. Interface 430 has an output to the microprocessor 440 whereby the processed images are passed to the RAM 450. The microprocessor 440 implements a storage reduction algorithm 445 to free up storage space in the RAM 450 once the RAM 450 reaches a predetermined percentage of its storage capacity.

The I/O interface 460 can be utilized to access the processed images in the RAM 450. In an embodiment, the video camera 400 includes access means (not shown) such as an on-board keypad or the like coupled to the I/O interface 460 for accessing data stored in the RAM 450. The accessed data can accordingly be reviewed on an attached Liquid Crystal Display (not shown) or the like. However, in an alternate embodiment, a remote device could be coupled to the camera 400 via the I/O interface 460 whereby data can be accessed from the RAM 450 by the remote data accessing device and saved into a permanent storage component of the remote data accessing device.

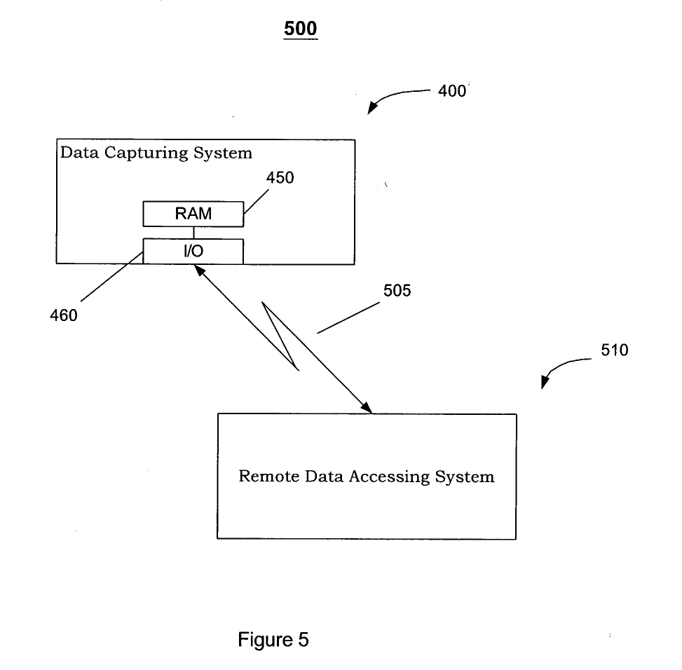

Accordingly, FIG. 5 shows an example of a system 500 in accordance with an alternate embodiment of the present invention. The system includes the video camera 400 of FIG. 4 and a remote data accessing device 510. The remote data accessing device 510 is coupled to the video camera 400 via the I/O interface 460 via a cable or wireless link 505 whereby the remote data accessing 510 accesses selected data from the RAM 450. Because the storage reduction algorithm 445 is utilized by the camera 400 to selectively free up storage space in the RAM 450, longer periods of time can be recorded with the camera 400. Consequently, especially valuable data, for instance video of a bank robbery, can be accessed by the remote data accessing device 510 and stored in a permanent memory component 515 of the remote data accessing device 510. Additionally, since longer periods of time can be recorded with the camera 400 less obvious events from a day, a week or a month earlier can be accessed by the remote data accessing device 510 as well.

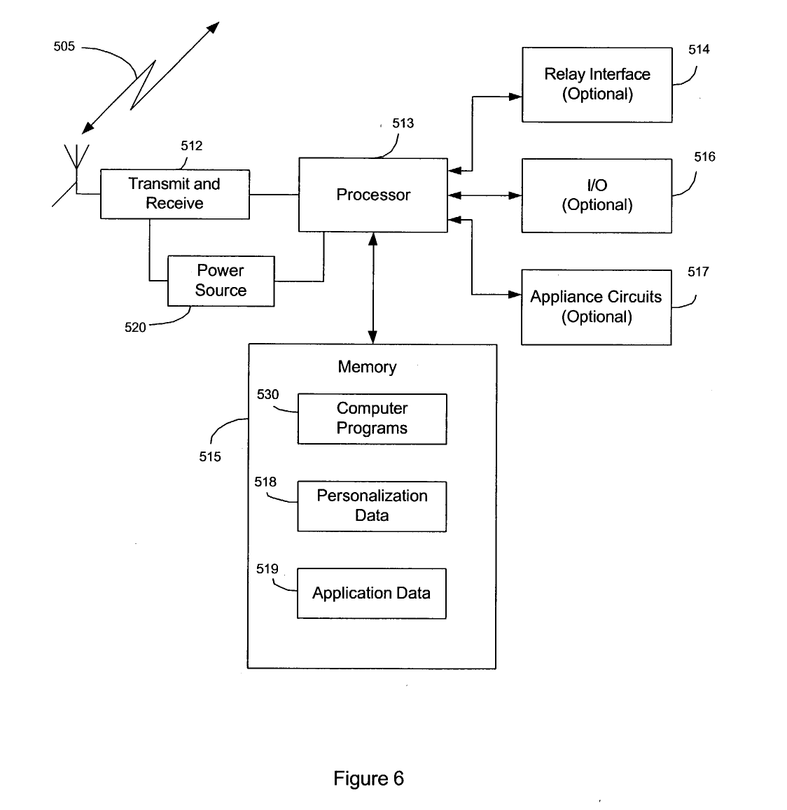

One of ordinary skill in the art will readily recognize that the remote accessing device 510 could comprise a variety of mobile devices (PDA, laptop computer, mobile phone, etc.) while remaining within the spirit and scope of the present invention. Accordingly, FIG. 6 shows a block diagram of hardware that could be included in a remote data accessing device 510 that could be utilized in accordance with an alternate embodiment of the present invention. The remote data accessing device 510 includes an antenna 511 configured to support wireless communication link 505. Antenna 511 couples to a transmit and receive section 512. Transmit and receive section 512 is compatible with the protocols that the remote data accessing device 510 uses to communicate with the video camera 400. An adjustable power source 520 couples to transmit and receive section 512 and to a processor 513. Processor 513 couples to an optional relay interface 514, a memory 515, an optional I/O section 516, and optional appliance circuits 517.

Processor 513 executes computer programs 530 which are stored in memory 515. A processor is one of the Intel family of microprocessors including the 386, 486 or Pentium microprocessors. However, other microprocessors including, but not limited to, Motorola's family of microprocessors such as the 68000, 68020 or the 68030 microprocessors and various Reduced Instruction Set Computer (RISC) microprocessors such as the PowerPC chip manufactured by IBM. Other RISC chips made by Hewlett Packard, Sun, Motorola and others may also be used.

Computer programs 530 define processes performed by processor 513. Processor 513 is capable of adjusting the power being supplied by the power source 520 to the transmit and receive section 512. Additionally, memory 515 can store personalization data 518 and application data 519. Personalization data 518 characterize a user or owner of the remote data accessing device 510 and may change from user to user. ID codes, passwords, and PINs are examples of personalization data 518 as are radio or TV channel presets, language preferences, and speed dial telephone numbers. Application data 519 is provided by performing peer applications, and may change from moment to moment.

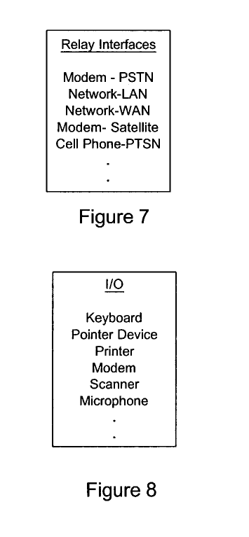

FIG. 7 shows a non-exhaustive list of relay interfaces 514 which may be included in the remote data accessing device 510. Referring to FIGS. 6 and 7, relay interfaces 514 may be configured as any of a wide variety of relay, routing, or gateway devices known to those skilled in the art. For example, the relay interfaces 514 may couple the remote data accessing device 510 to LANs or WANs. For example, web browser can be utilized to access the Internet. A web browser is a program that serves as a front end to the World Wide Web on the Internet. In order to view a web page, the web page address (URI) is typed into the browser's Location field.

FIG. 8 shows a non-exhaustive list of I/O devices 516 which may be included in the remote data accessing device 510. Referring to FIGS. 6 and 8, I/O devices 516 may be classified into input devices and output devices. Input devices may include keyboards, pointing devices, optical scanners, microphones, and other well-known input devices. Output devices may include printers, monitors, speakers, and other well-known output devices.

Those skilled in the art will readily appreciate that relay interface section 515, I/O section 516 and appliance circuits 517 are not mutually exclusive categories. For example, many devices fall into multiple categories. For example, a computer considered as an appliance may include both an I/O section and a relay interface. Likewise, a relay interface may serve an I/O role.

The communication link 505 could be a cable link or a wireless link. In accordance with an embodiment of the present invention, the communication link is a radio link in accordance with the Bluetooth Global Specification for wireless connectivity. Bluetooth is an open standard for short-range transmission of digital voice and data between mobile devices (laptops, PDAs, phones) and desktop devices. It supports point-to-point and multipoint applications. Unlike Infra-Red, which requires that devices be aimed at each other (line of sight), Bluetooth uses omni-directional radio waves that can transmit through walls and other non-metal barriers. Bluetooth transmits in the unlicensed 2.4 GHz band and uses a frequency hopping spread spectrum technique that changes its signal 1600 times per second. If there is interference from other devices, the transmission does not stop, but its speed is downgraded.

The Bluetooth baseband protocol is a combination of circuit and packet switching. Each data packet is transmitted in a different hop frequency wherein the maximum frequency hopping rate is 1600 hops/s. Bluetooth can support an asynchronous data channel, up to three simultaneous synchronous voice channels, or a channel which simultaneously supports asynchronous data and synchronous voice. Each voice channel supports 64 kb/s synchronous (voice) link. The asynchronous channel can support a symmetric link of maximally 721 kb/s in either direction while permitting 57.6 kb/s in the return direction, or a 432.6 kb/s symmetric link.

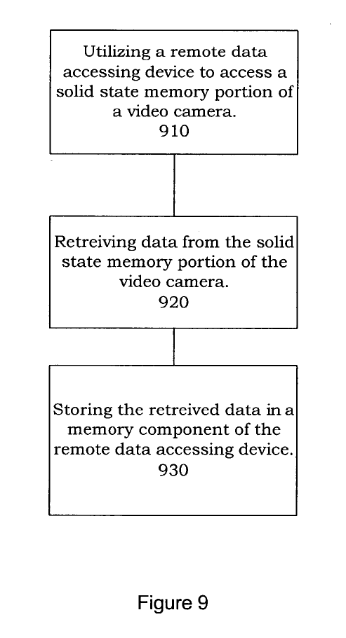

FIG. 9 shows a flowchart of a method in accordance with the above-described alternate embodiment of the present invention. A first step 910 includes utilizing a remote accessing device to access a solid state memory component of a video camera. A next step 920 includes retrieving data from the solid state memory component of a video camera. In an embodiment, the remote data accessing device accesses the solid state component of the video camera via a wireless link. A final step 930 includes storing the retrieved data in a memory component of the remote accessing device.

The invention may also be practiced in distributed computing environments where tasks are performed by remote processing devices that are linked through a communications network. In a distributed computing environment, program modules may be located in both local and remote memory storage devices. Execution of the program modules may occur locally in a stand-alone manner or remotely in a client/server manner. Examples of such distributed computing environments include local area networks of an office, enterprise-wide computer networks, and the Internet.

The Internet, which is a global web of interconnected computers and computer networks, integrates local area networks (LANs) located in various entities, such as businesses, libraries, federal agencies, institutes of learning, and research organizations into a single communication network. The Internet uses a common communication protocol suite, known as a Transmission Control Protocol/Internet Protocol (TCP/IP), which was specifically designed for the interconnection of different computer systems. Internal and external networks are linked by routers that route data packets from a sending network to another router or a receiving network. Gateways handle data transfer and conversion of messages from a sending network to the protocols used by a receiving network. Typically, gateways refer to devices that translate between applications. For example, e-mail gateways translate messages from one vendor's messaging program to another vendor's messaging program so that users with different e-mail programs can share messages over a network.

Typically, the computers connected to a wide area network such as the Internet are identified as either servers or clients. A server is a computer that stores files that are available to the other computers connected to the network. For example, an e-mail server manages message traffic and mail boxes for users, in addition to translation facilities or gateways that allow message exchange between different types of e-mail programs. A client is a computer connected to the network that accesses shared resources provided by a server. To obtain information from a server, a client makes a request for a file or information located on the server using a specified protocol. Upon reception of a properly formatted request, the server downloads the file or information to a local message store located at the client.

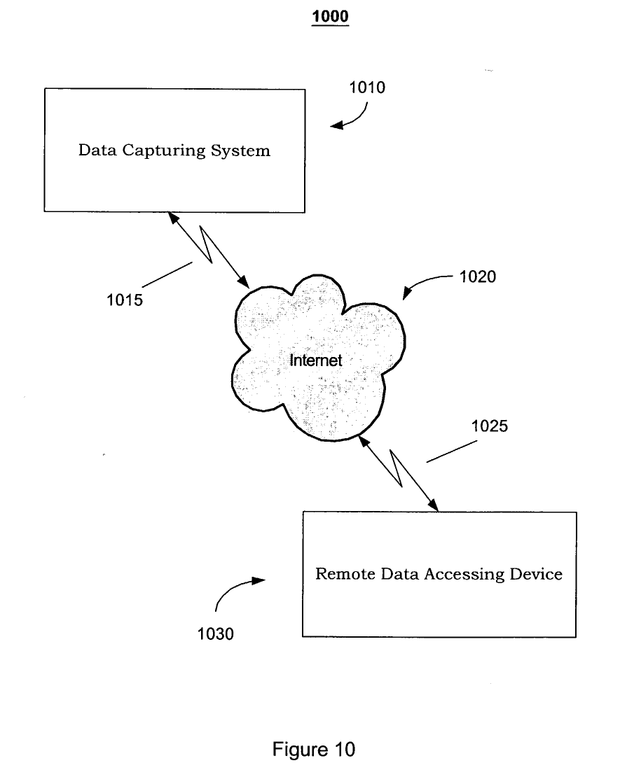

FIG. 10 shows a system 1000 in accordance with another embodiment of the present invention. The system 1000 includes a data capturing system 1010 (similar to the video camera 400), a network 1020 (e.g. the Internet) and a remote data accessing device 1030. The data capturing system 1010 is coupled to the network 1020 via communication link 1015 and the remote data accessing device 1030 is coupled to the network 1020 via communication link 1025. In an embodiment, the remote data accessing device 1030 accesses the data capturing system 1010 via the network 1020 through communication links 1015 and 1025 respectively. Accordingly, data can be retrieved from the solid state memory component of the data capturing system 1010 and stored in a permanent memory component of the remote data accessing device 1030.

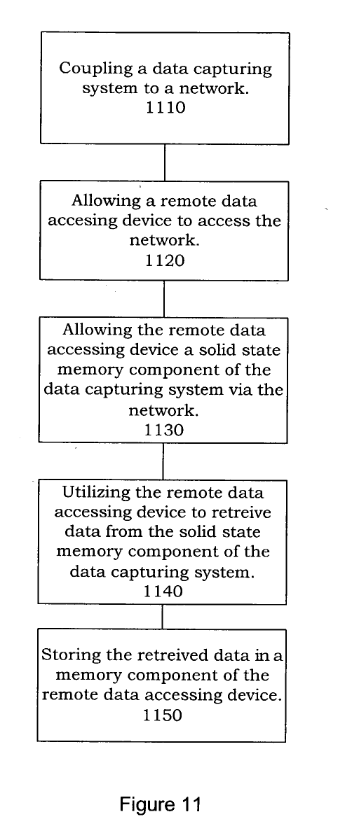

FIG. 11 shows a flowchart of the operation of the above-described embodiment of the present invention. A first step 1110 includes coupling a data capturing system to a network. In an embodiment, the network includes the Internet. A second step 1120 includes allowing a remote data accessing device to access the network. A next step 1130 involves allowing the remote data accessing device to access a solid state memory component of the data capturing system. A next step 1 140 includes utilizing the remote data accessing device to retrieve data from the solid state memory component of the data capturing system via the network. A final step 1150 includes storing the retrieved data in a permanent memory component of the remote data accessing device.

The above-described embodiments of the invention may also be implemented, for example, by operating a computer system to execute a sequence of machine-readable instructions. The instructions may reside in various types of computer readable media. In this respect, another aspect of the present invention concerns a programmed product, comprising computer readable media tangibly embodying a program of machine readable instructions executable by a digital data processor to perform the method in accordance with an embodiment of the present invention.

This computer readable media may comprise, for example, RAM (not shown) contained within the system. Alternatively, the instructions may be contained in another computer readable media such as a magnetic data storage diskette and directly or indirectly accessed by the computer system. Whether contained in the computer system or elsewhere, the instructions may be stored on a variety of machine readable storage media, such as a DASD storage (e.g. a conventional “hard drive” or a RAID array), magnetic tape, electronic read-only memory, an optical storage device (e.g., CD ROM, WORM, DVD, digital optical tape), paper “punch” cards, or other suitable computer readable media including transmission media such as digital, analog, and wireless communication links. In an illustrative embodiment of the invention, the machine-readable instructions may comprise lines of compiled C, C++, or similar language code commonly used by those skilled in the programming for this type of application arts.

A method and system for managing data in a system is disclosed. According to the present invention, the method and system includes the utilization of a programmable algorithm to periodically discard data in a memory component of a system. By utilizing a programmable algorithm to periodically discard data in the memory component of a system, data can be recorded over long periods of time at varying degrees of temporal and spatial resolution without the use of cumbersome video tapes and the like. Additionally, through the use of the method and system in accordance with the present invention, a user can select particularly useful data from the large amount of stored data and save it to a more permanent storage device.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A video surveillance camera comprising:
a sensor input for receiving the data;
a randomly accessible memory for storing the data; and
a microprocessor coupled to the sensor input and the randomly accessible memory for implementing a programmable algorithm to reduce the amount of the data stored in the randomly accessible memory of the system wherein the programmable algorithm comprises:
periodically checking an amount of available storage in the randomly accessible memory; and
reducing the amount of data in the randomly accessible memory based on the 11 amount of available storage in the randomly accessible memory; and
an interface coupled to the randomly accessible memory for providing access to a portion of data in the randomly accessible memory.

2. The video surveillance camera of claim 1 wherein reducing the amount of data in the randomly accessible memory further comprises deleting a portion of the data from the randomly accessible memory.

3. The video surveillance camera of claim 1 wherein reducing the amount of data in the randomly accessible memory further comprises lowering a resolution of a portion of the data from the randomly accessible memory.

4. A method for managing data in a system comprising:
receiving data from an input portion of the system;
storing the data in a solid state memory portion of the system; and
utilizing a programmable algorithm to reduce the amount of the data stored in the solid state memory portion of the system.

5. The method of claim 4 wherein the solid state memory portion comprises flash random access memory.

6. The method of claim 5 wherein utilizing a programmable algorithm comprises:
utilizing a microprocessor to implement the programmable algorithm.

7. The method of claim 6 wherein the programmable algorithm comprises:
periodically checking an amount of available storage in the solid state memory portion; and
selectively reducing the amount of data in the solid state memory portion based on the amount of available storage in the solid state memory portion.

8. The method of claim 7 wherein reducing the amount of data in the solid state memory portion further comprises deleting a portion of the data from the solid state memory portion.

9. The method of claim 7 wherein reducing the amount of data in the solid state memory portion further comprises lower a resolution of a portion of the data in the solid state memory portion.

10. The method of claim 7 wherein the system comprises a video surveillance camera.

11. The method of claim 10 further comprising:
utilizing a remote device to access a portion of the data in the solid state memory portion.

12. The method of claim 11 wherein the remote device comprises a personal digital assistant.

13. A system for managing data comprising:
a sensor input for receiving the data;
a solid state memory portion for storing the data; and
implementation means coupled to the sensor input and the solid state memory portion for implementing a programmable algorithm to reduce the amount of the data stored in the solid state memory portion of the system.

14. The system of claim 13 wherein the solid state memory portion comprises flash random access memory.

15. The system of claim 13 wherein the implementation means comprises a microprocessor.

16. The system of claim 15 wherein the programmable algorithm comprises:
periodically checking an amount of available storage in the solid state memory portion; and
reducing the amount of data in the solid state memory portion based on the amount of available storage in the solid state memory portion.

17. The system of claim 16 wherein reducing the amount of data in the solid state memory portion further comprises deleting a portion of the data from the solid state memory portion.

18. The system of claim 16 wherein reducing the amount of data in the solid state memory portion further comprises lower a resolution of a portion of the data in the solid state memory portion.

19. The system of claim 16 further comprising access means coupled to the solid state memory portion for accessing a portion of the data in the solid state memory portion.

20. The system of claim 19 wherein the access means further comprises a local user interface.

21. The system of claim 19 wherein the access means further comprises an I/O port capable of being accessed by a remote device.

22. A computer readable medium comprising program instructions for managing data in a system, the program instructions comprising the steps of:
receiving data from an input portion of the system;
storing the data in a solid state memory portion of the system; and
utilizing a programmable algorithm to reduce the amount of the data stored in the solid state memory portion of the system.
